(19) United States
(12) Patent Application Publication
(10) Pub. No.: US 2008/0209194 A1
(43) Pub. Date: Aug. 28, 2008

(54) Systems and methods for providing configuration change information on a per setting basis

(75) Inventors: Senthil Prabakaran, Portland, ME (US); John A. McNamara, Portland, ME (US)

Correspondence Address: PATRICK R. SCANLON;PRETI FLAHERTY BELIVEAU & PACHIOS LLP, ONE CITY CENTER, PORTLAND, ME, 04112-9546, US

(73) Assignee: DWITA, Inc.

(21) Appl. No.: 11/710,896

(22) Filed: Feb. 26, 2007

(51) Int. Cl. G06F 9/00

(52) U.S. Cl. 713/1

(57) ABSTRACT

Computer systems and methods are provided for presenting configuration change information on a per setting basis. This includes displaying one or more configuration settings, and receiving a user input that identifies a selected configuration setting. Configuration change information for the selected configuration setting is then displayed in response to the user input. In another aspect, a computer readable medium contains instructions for controlling a computer system to perform a method of providing configuration change information on a per setting basis.

### BACKGROUND OF THE INVENTION

This invention relates generally to configuration change management and more particularly to software for tracking changes to configuration settings on a per setting basis.

Computer programs typically have a number of configuration settings that allow users to control or dictate a wide variety of characteristics particular to the program, such as functionality, appearance, etc. For example, in the Microsoft Word software application, the Tools/Options menu command presents numerous configuration settings that provide options for viewing, editing, saving and printing documents. Configuration settings generally define the overall operation of a computer program in accordance with user preferences.

In most computer programs, if a user makes a change to one or more configuration settings, no record of the change is recorded. Thus, if the user subsequently wishes to revert back to one or more of the previous settings, he or she must be able to recall what the initial settings were. This can be very difficult with many computer programs, such as e-mail systems in which there are typically thousands of configuration settings.

Some computer programs provide a configuration backup and restore function, which essentially provides a snapshot of the entire configuration of a system or subsystem at a given point in time. Because such backup and restore tools pertain to an entire system or subsystem, as opposed to a per setting basis, the granularity of the tool is quite low. Furthermore, such tools are often built separately and not integrated with the user interface of the program, meaning that a display of the history of the configuration is usually presented as a printed report. This presents an administrator or end user with multiple locations to change the configuration, and permits reverting back to previous setting states only at the system or subsystem level.

### SUMMARY OF THE INVENTION

In one embodiment, the present invention provides a computer system including a display, means for changing configuration settings, and means for identifying a selected configuration setting. A database is included for storing configuration change information. The computer system includes a processor that is responsive to a user input identifying a selected configuration setting to cause the display to display configuration change information for the selected configuration setting.

In another embodiment, the present invention provides a method of using a computer system to provide configuration change information on a per setting basis. The method includes displaying one or more configuration settings, and receiving a user input that identifies a selected configuration setting. The method then displays configuration change information for the selected configuration setting in response to the user input.

In yet another embodiment, the present invention provides a computer readable medium containing instructions for controlling a computer system to perform the method of providing configuration change information on a per setting basis discussed above.

The present invention and its advantages over the prior art will be more readily understood upon reading the following detailed description and the appended claims with reference to the accompanying drawings.

### DESCRIPTION OF THE DRAWINGS

The subject matter that is regarded as the invention is particularly pointed out and distinctly claimed in the concluding part of the specification. The invention, however, may be best understood by reference to the following description taken in conjunction with the accompanying drawing figures in which:

FIG. 1 is a block diagram of a computer system for implementing configuration tracking software that provides configuration change information on a per setting basis.

FIG. 2 shows a representation of a screen display of a configuration window as displayed by a computer system implementing the configuration tracking software.

FIG. 3 shows a representation of a screen display that includes a user interface from the configuration tracking software presenting configuration change information.

FIG. 4 shows a representation of a screen display that includes a user interface from the configuration tracking software presenting default information.

### DETAILED DESCRIPTION OF THE INVENTION

The present invention relates to computer systems, software and methods for providing a history of configuration setting changes for a selected configuration setting (i.e., on a per setting basis). The present invention generally utilizes a user interface that displays information about the history of changes (“configuration change information”) for individual configuration settings of a given computer program. (As used herein, the term “computer program,” refers generally to any collection of instructions that, when executed, causes a computer system to carry out a predetermined task or set of tasks. Examples of computer programs include, without limitation, operating systems, application software, modules, firmware, etc.) Configuration change information is displayed and utilized in a manner that does not introduce confusion about the present state of the configuration setting. A user can use the configuration change information to track and audit changes to the configuration, revert to an older setting state, and report on the history of the setting. The ability to track changes at the individual configuration setting level benefits system administrators in diagnosing issues with the computer program and helps in complying with security and other regulatory standards.

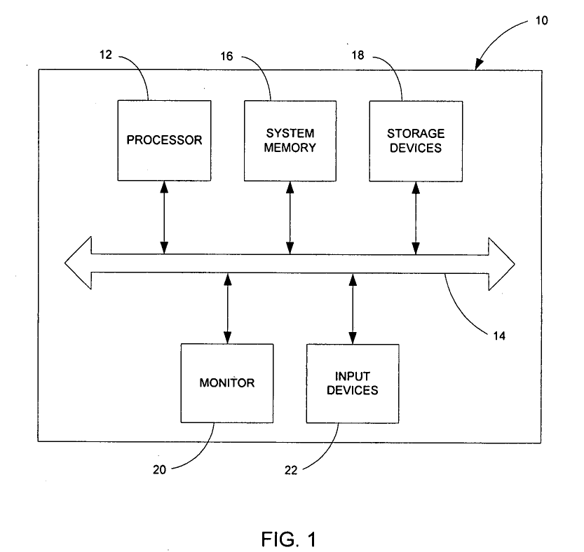

FIG. 1 shows an exemplary computer system 10 on which software for providing configuration change information on a per setting basis can be implemented. While only one possible configuration of the computer system 10 is shown for sake of convenience, it should be noted that many other configurations are possible. Furthermore, the present invention could be implemented on a single computer device or a computer network comprising multiple computing devices. Thus, as used herein, the term “computer system” encompasses not only a single, standalone computer but also two or more computers linked together via a communications network.

The computer system 10 includes a processor 12 that communicates with other elements of the computer system 10 over a system bus 14. The system bus 14 may be any of several types of bus structures and may actually comprise multiple bus structures interconnected by various bridges, adapters and/or controllers. The computer system 10 further includes a system memory 16 that typically comprises a random access memory (RAM) and a read only memory (ROM). One or more storage devices 18 are provided for storing data and programs within the computer system 10. In one possible embodiment, the storage devices 18 can include: a hard disk drive for reading from and writing to a hard disk, a floppy disk drive for reading from or writing to a floppy disk, and an optical disk drive for reading from or writing to an optical disk such as a CD-ROM or other optical media. The hard disk drive, floppy disk drive, and optical disk drive would be connected to the system bus 18 by conventional interfaces (not shown). It should be appreciated by those skilled in the art that the storage devices 18 can include other types of computer readable media, such as magnetic tapes, flash memory cards, integrated circuit memory devices (e.g., EEPROM), and the like. As used herein, the term “computer readable medium” refers generally to any medium from which stored data can be read by a computer or similar unit. This includes not only removable media such as floppy disks, CD-ROMs, and the like, but also non-removable media such as a hard disk or an integrated circuit memory device.

Also coupled to the system bus 14 are a display 20, such as a monitor, remote terminal or the like, for outputting information to the user and one or more input devices 22 for allowing users to enter commands and/or information to the computer system 10. The input devices 22 will typically include at least a keyboard and a pointing device such as a mouse, touchpad, trackball, pointing stick, joystick, or the like. Other input devices, such as a scanner, light pen, microphone, game pad, etc., can also be included. A communication device 24, such as a modem (either wired or wireless), is included for providing the computer system 10 with a means for connecting to a computer network such as the Internet, other wide area network (WAN) or a local area network (LAN).

The computer system 10 is capable of running several computer programs that have one or more configuration settings and includes configuration tracking software for providing configuration change information on a per setting basis. Generally, the configuration tracking software comprises two parts: a database or configuration store and a user interface component. The database is primarily used to store configuration change information that can be retrieved when needed. The user interface component, when launched by a user, causes a user interface to be displayed on the display 20 so as to display configuration change information that uniquely identifies changes made to an individual, selected configuration setting. This displayed change information can include, but is not limited to, a listing of the changes made to the setting, the date and/or time each change was made; identity of the user making the change, and user comments regarding the change, such as the reasons that the change was made.

In one possible implementation, the computer system 10 could be a single computer on which the configuration tracking software resides. For instance, the configuration tracking software could be stored in the system memory 16 and/or on the system's hard disk. Alternatively, the configuration tracking software could be stored on a removable computer readable medium (such as a floppy disk, CD-ROM or the like) and accessed from the computer readable medium when it is inserted into the appropriate drive of the computer system 10.

Another possible implementation is a networked implementation. As mentioned above, the computer system 10 can comprise multiple computers linked together though a communications network. In such a networked environment, the entire configuration tracking software would reside on an administrator's workstation, or alternatively, the database would be in a central server and the user interface component would be on an administrator's workstation. One exception is a Terminal services mode. In this case, the configuration tracking software is installed on a Terminal Server and many administrators can remotely view the user interface on their local terminal. The present invention can also be implemented using a web interface. In this case, the configuration tracking software is installed on a web server, and administrators can use a web browser to view the user interface.

With any implementation, the configuration tracking software is utilized by first displaying one or more configuration settings so as to enable the user to select a particular configuration setting for which configuration change information is to be viewed. The present invention encompasses any manner of displaying configuration settings. For example, one manner for displaying configuration settings is a configuration window or property page for the associated computer program. Configuration windows are typically opened using a menu command such as File/Edit, Tools/Option, etc. A typical configuration window displays a number of configuration settings and the current value or state of each setting, using one or more of a number of different types of user interface control formats including, but not limited to, radio buttons, check boxes, list controls, tree views, sliders, etc. Configuration settings can also be viewed via a Microsoft Management Console (MMC), which is a management display framework for hosting administrative tools that can be used to administer networks, computers, services, and other system components. An MMC utilizes a tree structure comprising a plurality of nodes.

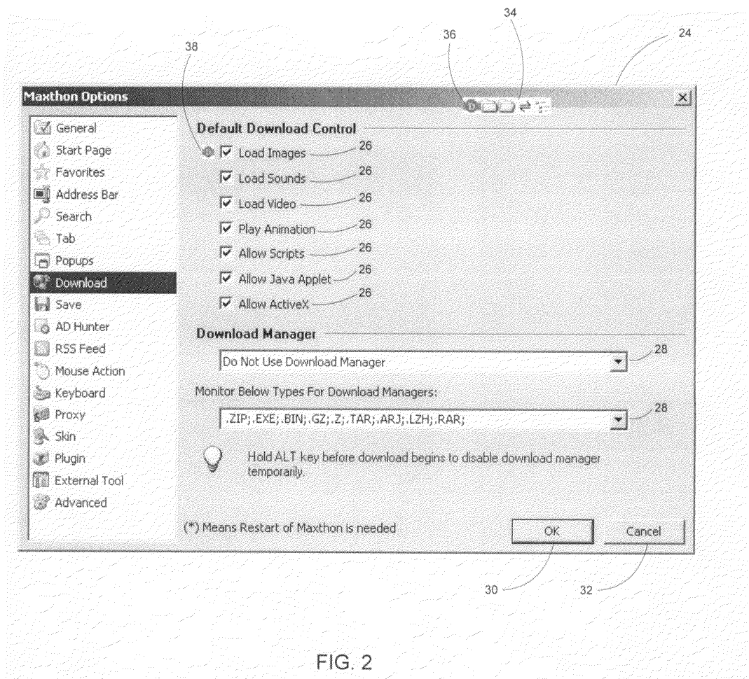

By way of example, FIG. 2 shows a configuration window 24 for the Maxthon Internet browser computer program, as displayed on the display 20 of the computer system 10 incorporating the configuration tracking software. The configuration window 24 includes a plurality of configuration setting controls, such as check boxes 26 and dropdown list controls 28, an “OK” button 30, and a “Cancel” button 32. A user can change a configuration setting by manipulating the appropriate configuration setting control using one or more of the input devices 22. For example, FIG. 2 shows that a check mark appears in the Load Images check box 26. This means that the Internet browser is configured to load images when downloading a web page. If a user did not want the Internet browser to load images, the user would simply select (e.g., click on) the Load Images check box 26, thereby removing the check mark and configuring the Internet browser to not load images when downloading a web page. When the user is finished making changes to the configuration settings, he or she would select the “OK” button 30, which closes the configuration window 24 and performs the changes. Selecting the “OK” button 30 also causes configuration change information relating to the changes to be recorded in the database. Selecting the “Cancel” button 32 causes the configuration window 24 to close and cancels any changes made to the configuration settings. The configuration window 24 can also include a toolbar 34. The toolbar 34 includes a launch button 36, the purpose of which is described below, and can include additional buttons that can be used for importing, exporting, reporting, etc.

In one embodiment, the configuration window 24 utilizes visual indicators to indicate the presence of configuration change information for particular configuration settings. That is, each configuration setting that has configuration change information associated with it would have such a visual indicator. For example, in FIG. 2 the Load Images check box 26 has a symbol 38 located next to it, thereby indicating that the this configuration setting has configuration change information. The symbol 38 can be a bitmap or an icon. Other forms of indicators, such as bold font, underline, etc., could be used.

The user launches a user interface to view the configuration change information for a particular configuration setting. There are a number of possible options for launching the user interface. One possible mode would be to click or double click the visual indicator associated with the desired configuration setting. Another way would be to use an accelerator key combination to launch the user interface for the configuration setting having focus. (The configuration setting having focus is the setting that will be responsive to input; this is typically denoted by some visual indication, such as the associated text being enclosed by a dotted rectangle.) Yet another option would be the launch button 36 on the toolbar 34, wherein clicking on the launch button 36 will launch the user interface for the configuration setting having focus. It should be noted that any combination of these launching options could be provided. For example, the configuration window 24 can include both symbols 38 in the form of clickable icons and a toolbar launch button 36, as shown in FIG. 2, or just one or the other of these launching options.

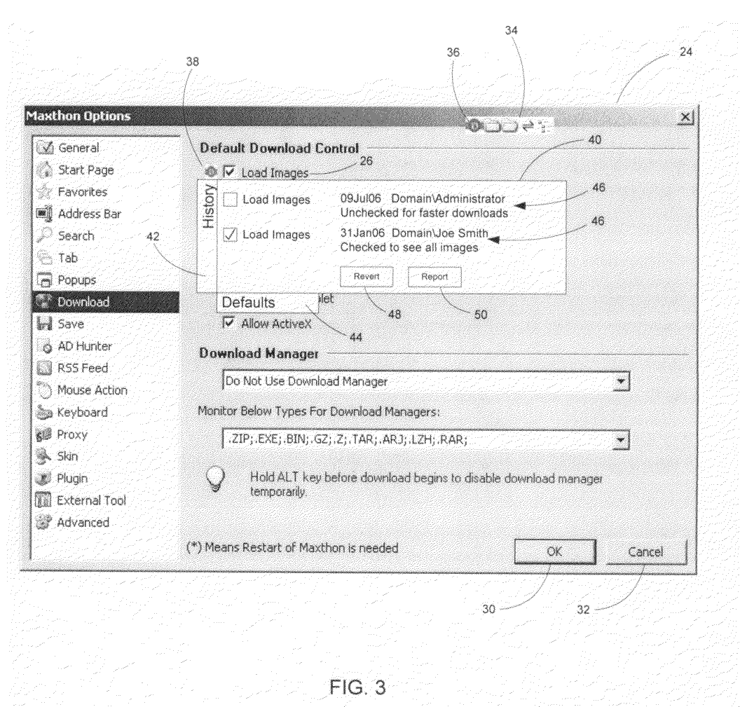

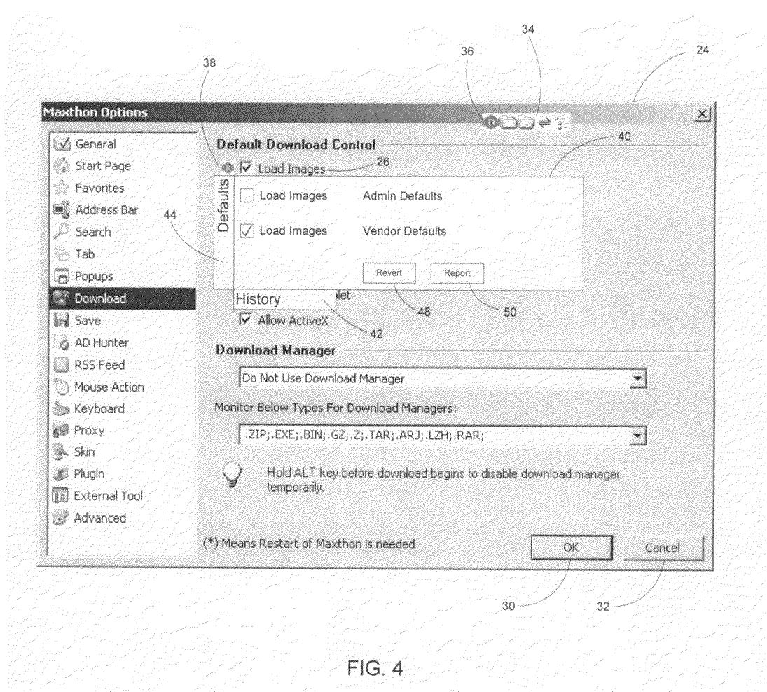

Once launched, the user interface is displayed on the display 20. The user interface displays previous states of the particular setting graphically, preferably using the same format with which the setting is displayed on the configuration window 24. As shown in FIGS. 3 and 4, the user interface comprises an information window 40. The information window 40 includes a history tab 42 and a defaults tab 44. Selecting the history tab 42 will cause the information window 40 to display the configuration change information for the particular configuration setting, as shown in FIG. 3. Selecting the defaults tab 44 will cause the information window 40 to display the default state or states for the particular configuration setting, as shown in FIG. 4. The information window 40 can be positioned to either overlay the configuration window 24, as shown in FIGS. 3 and 4 or not overlay the configuration window 24.

When the history tab 42 is selected, the information window 40 displays a list of previous states for the selected configuration setting. The list includes an entry 46 for each previous state; therefore, there is an entry 46 for each time the setting has been changed. In FIG. 3, the information window 40 overlies the configuration window 24 such that the list entries 46 are aligned sequentially below the configuration setting control for the selected configuration setting. The entries 46 are preferably, although not necessarily, listed chronologically by time of change, with the most recent entry listed first. Each entry 46 depicts the previous state using the same format as used on the configuration window 24. That is, the information window 40 uses the same setting control in depicting the previous states that the configuration window 24 uses for the corresponding configuration setting. In the example illustrated in FIG. 3, the information window 40 shows two entries 46 corresponding to two previous states of the Load Images configuration setting. Each entry 46 displays a previous state via a check box control, which is the same type of configuration setting control used for the Load Images configuration setting on the configuration window 24. The first entry 46 shows a check box that is not checked, indicating a previous state of being configured to not load images when downloading a web page. The second entry 46 shows a check box that is checked, indicating a previous state of being configured to load images when downloading a web page.

In addition to showing the previous state, each entry 46 includes additional information pertaining to the change. The additional information includes the date and/or time of the change, the user who changed the setting, and any user comments regarding the change; other types of additional information can also be included. In the illustrated example, the first entry 46 shows the change was made on Jul. 9, 2006 by the Administrator and provides the comment that the setting was “unchecked for faster downloads.” The second entry 46 shows the change was made on Jan. 31, 2006 by user “Joe Smith” and provides the comment that the setting was “checked to see all images.” The information window 40 also includes a “Revert” button 48, that when selected causes the configuration setting to revert to the previous state of the entry 46 having focus. The information window 40 also includes a “Report” button 50, that when selected causes a report of the entire history to be generated. Other action buttons (not shown) could be provided for additional functions such as printing and editing. These various actions could also be performed using accelerator key combinations such as Ctrl-Z, Ctrl-P, etc.

When the Defaults Tab 44 is selected, the information window 40 displays the default states for the particular configuration setting, as shown in FIG. 4. The defaults could include, but are not limited to, vendor defaults (i.e., what the creator/developer of the computer program specified as the default state), administrator defaults, etc. The user would be able to revert to one of the default states be clicking the Revert button 48 when the desired default value has focus.

In operation, a user can change a configuration setting in the configuration window 24 by manipulating the appropriate configuration setting control using one or more of the input devices 22. When a user makes one or more configuration changes, the configuration tracking software captures the relevant configuration change information (i.e., the new configuration setting states and additional information such as the date and/or time of the change and the user who made the change). This configuration change information is stored in the database when the user clicks on the “OK” button 30. The user is also able to enter comments about the change, if so desired. To do this, the user launches the information window 40 for the affected configuration setting and selects the history tab 42. The user's comment, which could be an explanation of the reason for making the change, is then entered in comment field of the appropriate listing entry 46. For example, the user could click on the comment field using the computer system's pointing device and enter the comment with the keyboard. Selecting the “OK” button 30 causes the comment to be recorded in the database, as part of the related configuration change information. The decision to enter comments is preferably left to the user's option, although the configuration tracking software could alternatively be set up to mandate entry of comments.

The process for viewing configuration change information for a particular configuration setting is as follows. The user first opens the configuration window 24 to display a plurality of configuration settings. The user then uses one or more of the input devices 22 to identify the desired configuration setting and launch the information window 40 corresponding launch the identified configuration setting. For example, as described above, the user could use the computer system's pointing device to select (e.g., via a single or double click) the visual indicator associated with the desired configuration setting or click on the toolbar launch button 36 after ensuring that the desired configuration setting has focus. The user could also employ an accelerator key combination. The user can then select the history tab 42 of the information window 40 to view the configuration change information.

While specific embodiments of the present invention have been described, it should be noted that various modifications thereto could be made without departing from the spirit and scope of the invention as defined in the appended claims.

What is claimed is:

1. A computer system that runs one or more computer programs, each computer program having one or more configuration settings, said system comprising:
a display;
means for changing configuration settings;
means for identifying a selected configuration setting;
a database of configuration change information; and
a processor coupled to said display, said means for changing, said means for identifying and said database, said processor being responsive to a user input identifying a selected configuration setting to cause said display to display configuration change information for said selected configuration setting.

2. The computer system of claim 1 wherein said configuration change information includes previous states of said selected configuration setting.

3. The computer system of claim 2 wherein said selected configuration setting is displayed on said display in a given format and said previous states are displayed using said format.

4. The computer system of claim 2 further comprising means for reverting to one of said displayed previous states.

5. The computer system of claim 2 wherein said configuration change information further includes the date and/or time changes were made and the identity of users making changes.

6. The computer system of claim 5 wherein said configuration change information further includes user comments regarding changes.

7. The computer system of claim 1 further comprising means for displaying default states of said selected configuration setting.

8. A method of using a computer system to provide configuration change information on a per setting basis, said method comprising:
displaying one or more configuration settings;
receiving a user input that identifies a selected configuration setting; and
displaying, in response to said user input, configuration change information for said selected configuration setting.

9. The method of claim 8 wherein said selected configuration setting is displayed in a given format and said configuration change information is also displayed in said format.

10. The method of claim 8 wherein displaying one or more configuration settings includes utilizing a visual indicator to indicate the presence of configuration change information for each configuration setting that has configuration change information associated therewith.

11. The method of claim 8 wherein displaying configuration change information for said selected configuration setting includes launching a user interface corresponding to said selected configuration setting.

12. The method of claim 11 wherein said user interface displays a list of previous states for said selected configuration setting.

13. The method of claim 12 wherein said previous states and said selected configuration setting are displayed using the same format.

14. The method of claim 12 wherein said list of previous states includes an entry for each previous state, and each entry includes additional information about the corresponding previous state.

15. The method of claim 14 wherein said additional information includes the date and/or time changes to said selected configuration setting were made and the identity of users making said changes.

16. The method of claim 15 wherein said additional information further includes user comments regarding said changes.

17. The method of claim 11 wherein said user interface displays default states for said selected configuration setting.

18. A computer readable medium containing instructions for controlling a computer system to perform a method of providing configuration change information on a per setting basis, wherein said method comprising:
displaying one or more configuration settings;
receiving a user input that identifies a selected configuration setting; and
displaying, in response to said user input, configuration change information for said selected configuration setting.

19. The computer readable medium of claim 18 wherein said instructions cause said selected configuration setting to be displayed in a given format and said configuration change information to also be displayed in said format.
